(19) United States
(12) Patent Application Publication
(10) Pub. No.: US 2006/0086551 A1
(43) Pub. Date: Apr. 27, 2006

(54) Truck hood actuator

(76) Inventors: Terry P. Cleland, Pickering (CA); Zbyslaw Staniewicz, Coldwater (CA); Gary J. Spicer, Mississauga (CA); Harvey J. Dix, Thornton (CA)

Correspondence Address: CLARK HILL, P.C., 500 WOODWARD AVENUE, SUITE 3500, DETROIT, MI, 48226, US

(21) Appl. No.: 11/256,812

(22) Filed: Oct. 24, 2005

Related U.S. Application Data
(60) Provisional application No. 60/621,335, filed on Oct. 22, 2004.
(60) Provisional application No. 60/658,665, filed on Mar. 4, 2005.
(60) Provisional application No. 60/721,790, filed on Sep. 29, 2005.

(51) Int. Cl. B62D 25/10

(52) U.S. Cl. 180/69.2

(57) ABSTRACT

A truck hood actuator is provided which, operating via a gear rack and DC motor-powered traveler or pinion gear and ring gear, can operate more quickly than a hydraulic actuator, or a worm or screw gear actuator. Further, by employing the disclosed gear rack and traveler, the actuator of the present invention can be readily employed and installed as an after market accessory or as OEM equipment at a lower cost than a hydraulic or other, more complex, actuators.

### RELATED APPLICATIONS

The present invention claims priority from: U.S. Provisional Patent Application 60/621,335, “Truck Hood Actuator”, filed Oct. 22, 2004; U.S. Provisional Patent Application 60/658,665, “Truck Hood Actuator”, filed Mar. 3, 2005; and U.S. Provisional Patent Application 60/721,790, “Truck Hood Actuator”, filed Sept. 29, 2005 and the entire contents of each of these provisional applications are incorporated herein by reference.

### FIELD OF THE INVENTION

The present invention relates to an actuator for opening and closing an engine compartment closure, such as a hood, of a truck or other vehicle. More specifically, the present invention relates to an electrically driven actuator for opening and closing an engine compartment closure on trucks and the like, which system can be installed at, or after, the time of manufacture of the truck.

### BACKGROUND OF THE INVENTION

Tractors for transport trucks and the like typically have large and heavy hoods enclosing their engine compartments. For maintenance and safety inspection purposes, it is necessary for mechanics, owners and/or operators to routinely open and close these hoods. However, due to the weight, location and size of these hoods, it can be difficult for many people to safely open and close these hoods. In fact, straining of and/or injury to the back of the person opening and closing the hood is a common complaint.

It is known to provide various mechanical devices to assist in the opening and closing of truck hoods. For example, U.S. Pat. No. 4,359,199 shows a spring mechanism to partially offset the weight of the hood to assist in moving it to an open position. It is also known to provide mechanisms to enhance safety while opening of a truck hood, for example U.S. Pat. No. 4,281,733 shows a hydraulic damper which operates to slow the opening of a heavy truck hood, the system slowing the movement of the hood once it is over-center so that the hood does not slam into its open stops.

However, problems exist with such systems in that they still generally require significant effort on the part of the person opening and closing the hood.

With particularly heavy hoods, such as cab-over designs wherein the whole cab of the truck pivots forward for access to the engine compartment, it is known to provide powerful spring and/or hydraulic assist mechanisms to move the cab between open and closed positions. However, problems exist with such systems if they were employed for opening non-cab-over hoods in that they generally are quite slow at opening or closing the hood, which is problematic when a hood must be opened very regularly for safety inspection purposes. Further, such hydraulic systems generally must be designed and installed at the time of manufacture of the vehicle and are expensive to construct and can add significant weight to the truck.

### SUMMARY OF THE INVENTION

It is an object of the present invention to provide a novel actuator for opening and closing a moveable closure for the engine compartment of a truck or the like which obviates or mitigates at least one disadvantage of the prior art.

According to a first aspect of the present invention, there is provided an actuator for opening and closing a moveable closure for the engine compartment of a truck or the like, comprising: a gear rack for mounting to the truck; a traveler including a motor and a pivot point, the motor operable to move the traveler along the gear rack; and a lift rod extending between the pivot point on the traveler and a pivot point on the moveable closure, the lift rod moving the moveable closure to an open position when the traveler moves in a first direction along the gear rack and moving the moveable closure to a closed position when the traveler moves in a second direction along the gear rack.

Preferably, the actuator also includes an electronics controller connected to the motor, the electronics controller being operable to deactivate the motor when the traveler reaches a defined first or second position on the gear rack. Also preferably, the lift rod comprises an assembly of an upper rod and a lower rod, the upper and lower rods being kept in engagement by a removable member and the removable member can be removed to allow disengagement of the upper rod from the lower rod to allow manual opening of the closure member.

According to another aspect of the present invention, there is provided an actuator for opening and closing a moveable closure for the engine compartment of a truck or the like, comprising: a motor driven pinion gear; a ring gear rotatably mounted to the truck and engaging the pinion gear, the ring gear further including an actuator arm extending radially from the ring gear; and a lift rod extending between a pivot point on the actuator arm and a pivot point on the moveable closure, the lift rod moving the moveable closure to an open position when the pinion gear rotates in a first direction and moving the moveable closure to a closed position when the pinion gear rotates in a second direction.

The present invention provides a truck hood actuator which, in one embodiment, operates via a gear rack and DC motor-powered traveler and can operate more quickly than a hydraulic actuator, or a worm or screw gear actuator. In another embodiment, a pinion and ring gear drive provides similar advantages. Further, the drives of the present invention can be readily employed and installed as an after market accessory or as OEM equipment at a lower cost than a hydraulic or other, more complex, actuators.

### BRIEF DESCRIPTION OF THE DRAWINGS

Preferred embodiments of the present invention will now be described, by way of example only, with reference to the attached Figures, wherein:

FIG. 1 a side view of an actuator in accordance with the present invention, installed in the engine compartment of a truck;

FIG. 2 shows a front view of the actuator of FIG. 1;

FIG. 3 shows the lift rod assembly of the actuator of FIG. 1 and its mounts;

FIG. 4 shows an exploded view of the traveler of the actuator of FIG. 1;

FIG. 5 shows an example of the geometry of the hood and actuator of FIG. 1;

FIG. 6 shows a schematic side view of another embodiment of an actuator in accordance with the present invention, installed in the engine compartment of a truck with the hood closed;

FIG. 7 shows the actuator of FIG. 6 with the truck hood open;

FIG. 8 shows a side view of the actuator of FIG. 6;

FIG. 9 shows an example of the geometry of the hood and actuator of FIG. 6;

FIG. 10 shows a side view of another actuator in accordance with the present invention;

FIG. 11 shows a lift rod assembly for use with the present invention;

FIG. 12 shows another embodiment of the present invention which includes the use of biasing means to counter some of the weight of the hood;

FIG. 13 shows a exploded perspective view of another embodiment of an actuator in accordance with the present invention; and

FIG. 14 shows a side exploded view of the shaft, coil spring and noose ring of an alternative embodiment of the actuator of FIG. 13.

### DETAILED DESCRIPTION OF THE INVENTION

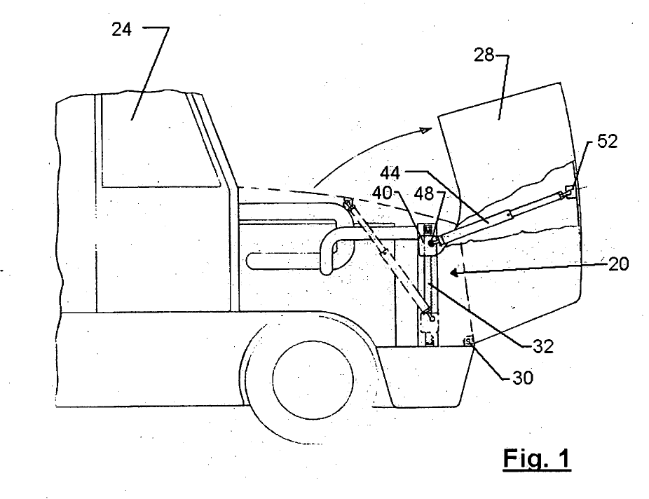

An actuator in accordance with the present invention is indicated generally at 20 in FIG. 1. As shown, actuator 20 is installed in the engine compartment of a truck 24 and is operable to move an engine compartment closure, in this embodiment hood 28, enclosing the engine compartment of truck 24 between an open position, illustrated in the Figure in solid line, and a closed position illustrated in dashed line. Hood 28 is mounted to truck 24 by a suitable hinge mechanism 30 at the front end of the engine compartment of truck 24 and by a suitable latch mechanism, not shown, at the rear end of the engine compartment.

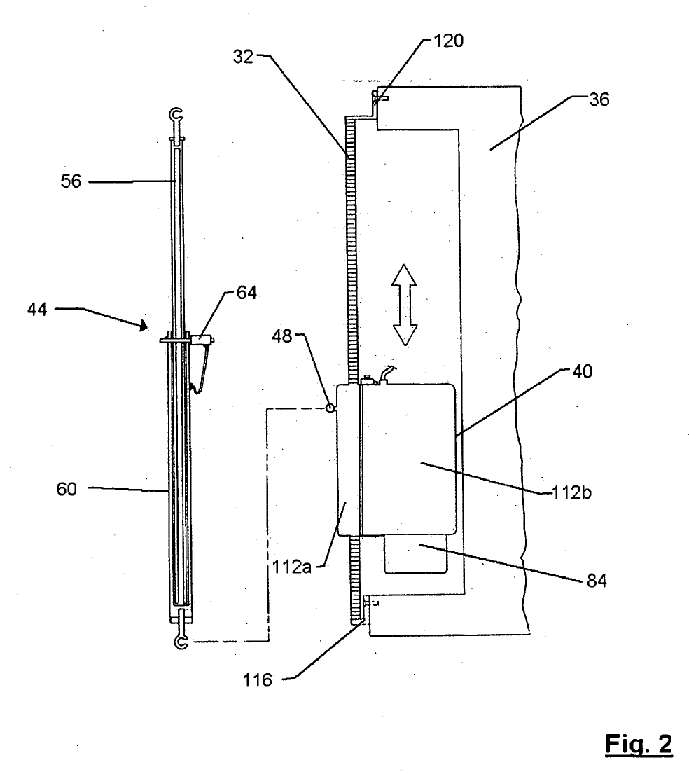

As best seen in FIG. 2, actuator 20 comprises a geared rack 32 which is mounted to truck 24 within the engine compartment. Preferably, each end of rack 32 is affixed to a suitable attachment point on truck 24, such as to the mount 36 for the radiator in the engine compartment.

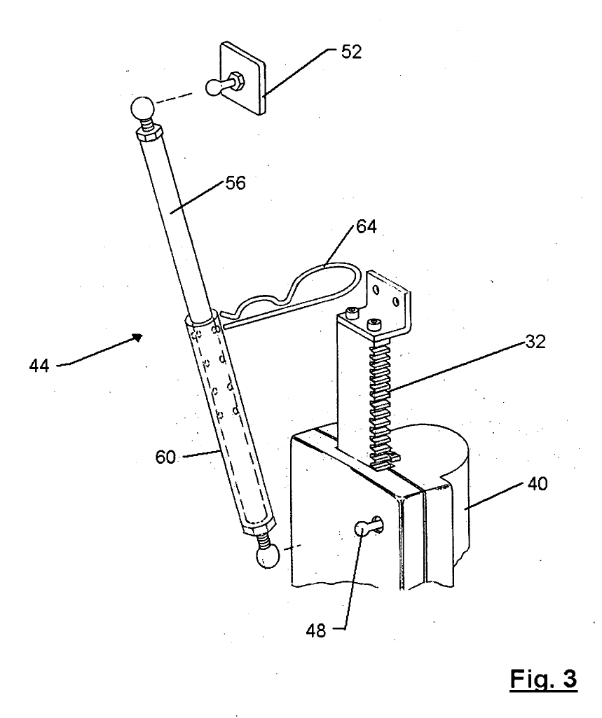

A traveler 40 moves along geared rack 32, as described below, and one end of a lift rod assembly 44 connects to a mount point 48 on traveler 40 and the other end of lift rod assembly 44 connects to a mounting point 52 on hood 28, as best seen in FIG. 3.

Preferably, lift rod assembly 44 comprises an upper rod 56 which is received within a lower rod 60. The relative position of upper rod 56 within lower rod 60, and thus the overall length of lift rod assembly 44, is maintained by a removable pin 64 which extends through a aperture in lower rod 60 and through one of a series of apertures in upper rod 56. As will be apparent, the length of lift rod assembly 44 can easily pin altered by removing pin 64, moving upper rod 56 with respect to lower rod 60 until another aperture through upper rod 56 aligns with the aperture in lower rod 60 and then reinserting pin 64. It is contemplated that actuator 20 can be employed as an after market option and the adjustability of the overall length of lift rod assembly 44 allows actuator 20 to be easily fit to a large range of trucks. However, the present invention is not limited to use with an adjustable length lift rod and a rod with an appropriate fixed length can also be employed.

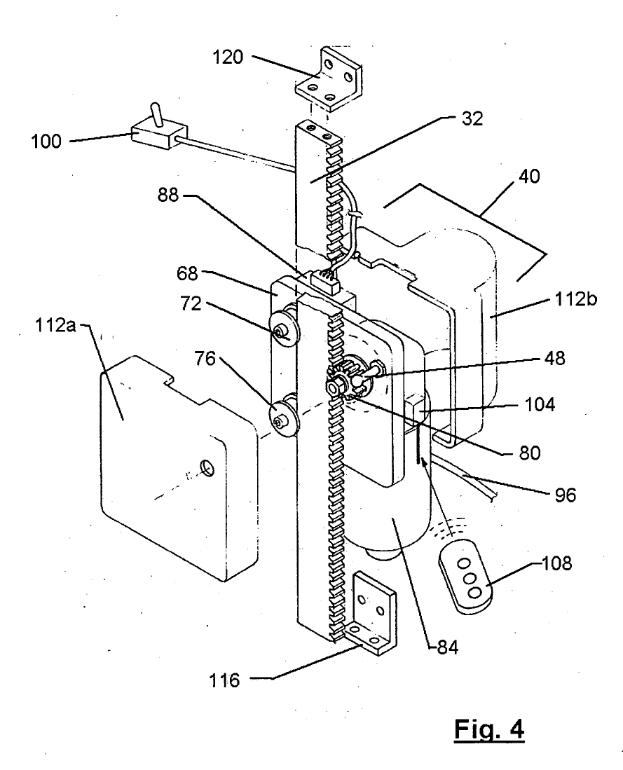

Traveler 40 and geared rack 32 are shown in more detail in FIG. 4. As illustrated, traveler 40 includes a carriage 68 which has two idler wheels 72 and 76 which engage the flat side of geared rack 32 and a pinion gear 80 which engages the toothed side of geared rack 32. Pinion gear 80 is driven by a DC motor 84 mounted to carriage 68 and, as DC motor 84 rotates pinion gear 80 in a first direction, traveler 40 moves up gear rack 32 and, as DC motor 84 rotates pinion gear 80 in the opposite direction, traveler 40 moves down gear rack 32.

In the present embodiment, an electronics package 88 is also mounted to carriage 68, although it will be apparent to those of skill in the art that electronics package 88 can be mounted to gear rack 32 or separately to a suitable mounting location within the truck that actuator 20 is installed in. Electronics controller 88 is supplied with DC power from a cable 96 which is connected to a DC power source on the truck that actuator 20 is installed on and cable 96 is long enough to allow traveler 40 to move between the upper and lower extremes of gear rack 32.

Electronics controller 88 is responsive to an operating switch 100, which allows a user to operate actuator 20 to open, close or stop hood 28. When switch 100 is moved to the “open” position, electronics controller 88 supplies DC power to motor 84 to move traveler 40 up gear rack 32. When switch 100 is moved to the “close” position, electronics controller 88 supplies DC power to motor 84 to move traveler 40 down gear rack 32. When switch 100 is moved to the “stop” position, electronics controller 88 immediately removes the power from motor 84, whether or not hood 28 is fully opened or closed. This “stop” function is provided to allow a user to stop unsafe operation of actuator 20, which may occur due to a person or object being in the way of hood 28 or other unsafe condition.

Preferably, electronics controller 88 includes a current sensing circuit, or other sensor, which can detect if DC motor 68 stalls, which will occur when traveler 40 reaches either extremity of geared rack 32, or when hood 28 abuts a person or object preventing further movement of hood 28.

When a stall condition is detected, electronics controller 88 will remove the DC power from motor 84. If traveler 40 has reached an extremity of geared rack 32, the removal of DC power from motor 84 completes the opening, or closing, of the hood 28. If hood 28 has abutted an object preventing further opening or closing of hood 28, removal of the DC power from motor 84 by electronics controller 88 serves as a safety precaution to prevent damage to hood 28 and/or injury to people.

As will be apparent to those of skill in the art, after electronics controller 88 has detected a stall condition, reactivation of switch 100 will cause electronics controller 88 to reapply DC power to motor 84 to, depending upon the mode in which switch 100 was activated, raise or lower traveler 40 until the next stall condition is detected or until switch 100 is placed in the off position.

While electronics controller 88 preferably employs the described stall detector, the present invention is not so limited and any other suitable method of detecting traveler 40 reaching a movement extremity, such as limit switches, can also be employed. Further, the present invention is not limited to the use of a stall sensor for detecting unsafe conditions, such as hood 28 abutting an object, and any other suitable means such as known ultrasonic and/or radar-like systems for detecting such unsafe conditions, as would occur to those of skill in the art, can also be employed.

It is contemplated that switch 100 will be located in the passenger compartment of truck 24, preferably on the passenger side, to promote the convenient and safe operation of actuator 20. However, it is also contemplated that electronics controller 88 can also include a wireless receiver 104, such as a radio or infrared receiver, allowing actuator 20 to be operated from a portable transmitter 108, such as a key fob or the like, either in addition to from switch 100 or instead of from switch 100.

Another function of electronics controller 88 is in the mitigation of backdriving of motor 84 by hood 28. Specifically, as will be apparent to those of skill in the art, when the center of gravity of hood 28 moves over center (both when closing or opening hood 28), the weight of hood 28 can act to backdrive motor 84 which can result in hood 28 moving faster than intended (or desired), resulting in damage to motor 84 and/or undesired operation of actuator 20. Accordingly, in a presently preferred embodiment of the present invention electronics controller 88 is operable to remove the supply of current to motor 84 and to either inter-connect the current supply leads of motor 84 or to place a electrically resistive element in circuit therewith, such that motor 84 will act as a generator/brake to avoid backdriving of motor 84. A variety of methods can be employed by electronics controller 88 to detect the onset of overdriving, including using the above mentioned current sensing circuitry to detect a drop in the current being supplied motor 84, indicating that motor 84 is being overdriven. Alternately, the rotational speed of motor 84 can be monitored by electronics controller 88, etc.

While less preferred, a manual switch can be used in place of electronics controller 88, allowing DC power to be applied to motor 84 in either of two polarities to open or close hood 28, although this requires the user to hold the manual switch in the appropriate position until hood 28 has been opened or closed and to release the manual switch when the desired position has been obtained. By locating the switch well away from hood 28, this embodiment can enforce a level of safety as when the operator is holding the switch to maintain operation of actuator 20, they will necessarily be out of the way of harm from movement of hood 28.

A safety cover, comprising a front portion 112a and a rear portion 112b is mounted about carriage 68 and motor 84 and electronics controller 88 to prevent unintentional access to idler wheels 72 and 76 and pinion gear 80 and to motor 84 and electronics controller 88.

Also shown if FIG. 4 are mounting brackets 116 and 120 which are one of the suitable manners by which gear rack 32 can be mounted within the engine compartment of truck 24.

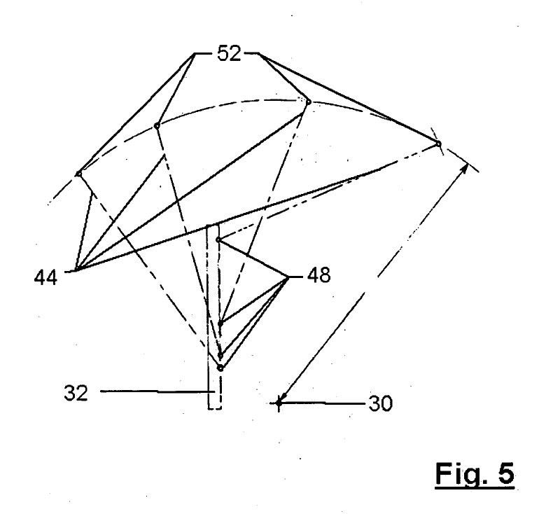

As should now be apparent, as traveler 40 moves up gear rack 32, lift rod assembly 44 acts between mounting point 48 on traveler 40 and mounting point 52 which is attached to hood 28, to move hood 28 to its open position. FIG. 5 shows one possible geometry of the movement of mounting point 52 on hood 28 (not shown in the Figure), mounting point 48 on traveler 40 (not shown in the figure) and lift rod assembly 44 as traveler 40 is moved between the bottom and the top of gear rack 32. As shown, hood 28 is pivoted about hinge mechanism 30, swinging hood 28 forward about hinge mechanism 30 to open hood 24 and swinging hood 28 backward about hinge mechanism 30 to close hood 28.

In the illustrated geometry, as hood 28 is opened by actuator 20, the center of mass of hood 28 will eventually move in front of hinge mechanism 30. At this point, actuator 20 will effectively begin acting as a brake as the weight of hood 28 would otherwise act to rapidly pivot hood 28 about hinge mechanism 30 to open hood 28. Similarly, as hood 28 is closed by actuator 20, the center of mass of hood 28 will eventually move behind hinge mechanism 30 and, at this point, actuator 20 will effectively begin acting as a brake as the weight of hood 28 would otherwise act to rapidly pivot hood 28 about hinge mechanism 30 to close hood 28. Thus, in one part of each open or close operation, actuator 20 acts initially as a prime mover to lift the weight of hood 28 and subsequently acts as a brake to retard self-movement of hood 28.

In the event of a failure of actuator 20, or a dead vehicle battery or other problem with the electrical supply to electronics controller 88, it is necessary that the owner and/or operator of truck 24 still be able to open hood 28 for necessary inspections and/or maintenance. In such a case, the owner and/or operator can reach pin 64 via the wheel well opening on truck 24 to remove pin 64 from lift rod assembly 44, thus allowing hood 28 to be opened, pulling upper rod 56 from lower rod 60. Once the defective battery or other fault has been repaired, the owner and/or operator of truck 24 can reinsert upper rod 56 into lower rod 60 and reinsert pin 64, thus re-enabling actuator 20.

It is contemplated that actuator 20 can relatively quickly move hood 28 between open and closed positions. Further, it is contemplated that, while actuator 20 can be provided as original equipment on truck 24, actuator 20 can also easily be fitted to truck 24 as an after market accessory. All that is needed in this later case is to appropriately mount gear rack 32 within the engine compartment, attach mounting point 52 to an appropriate location on hood 28, connect an appropriate supply of DC power to cable 96 and to install lift rod assembly 44 between mounting points 48 and 52, with pin 64 inserted into the appropriate aperture in lower rod 60. Switch 100 can then be mounted in a desired location or portable transmitter 108 can be used instead.

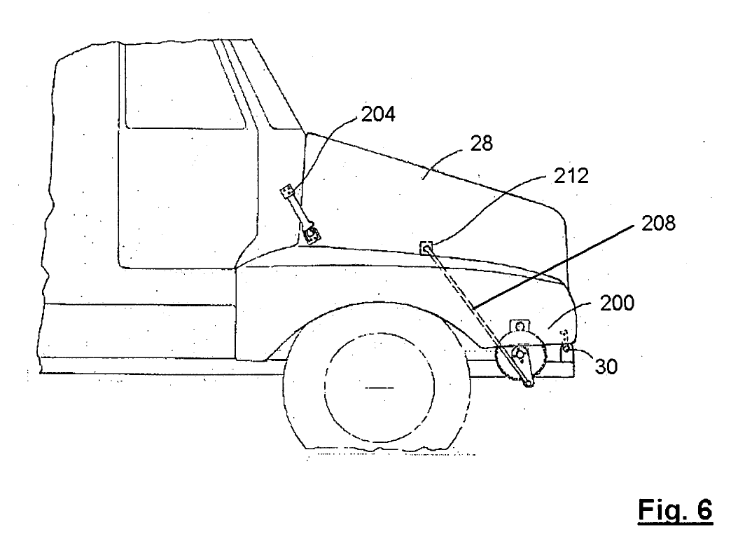

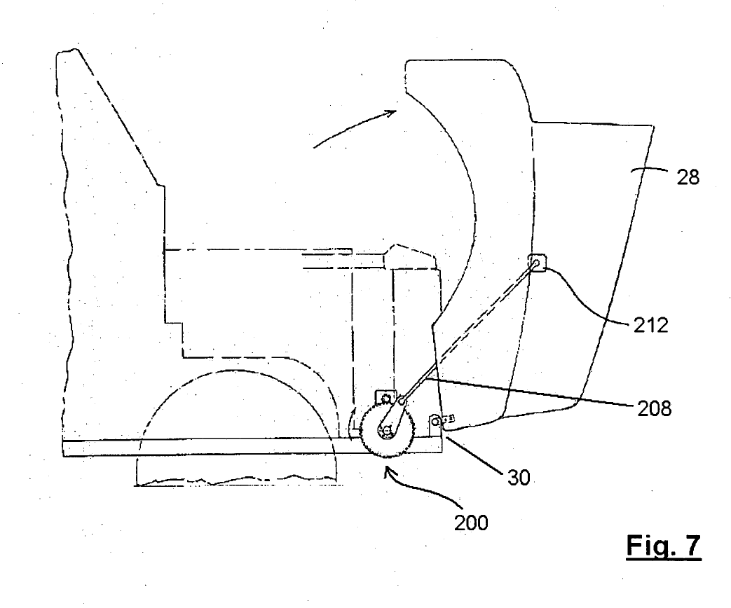

Another embodiment of the present invention is illustrated in FIGS. 6 through 9. In the Figures, an actuator in accordance with the present invention is indicated generally at 200. In FIG. 6, the truck hood 28 is shown in the closed position and, in FIG. 7, truck hood 28 is shown in the opened position. As with the previous embodiment described above, truck hood 28 pivots about a suitable hinge mechanism 30 which works between the frame of the truck and hood 28 and hood 28 can be maintained in the closed position by a latch 204, or other suitable mechanism.

Again, as in the previously described embodiment, a lift rod 208 extends between a pivot point 212, mounted to hood 28, and actuator 200, as is described in more detail below. Lift rod 208 can be an assembly, such as that described above with respect to the embodiment of FIGS. 1 through 5, such that the length of lift rod 208 can be altered to permit easy installation of actuator 200 as an after market item and/or which can be disconnected to allow manual opening or closing of the hood in case of failure of actuator 200 or the vehicle's power system.

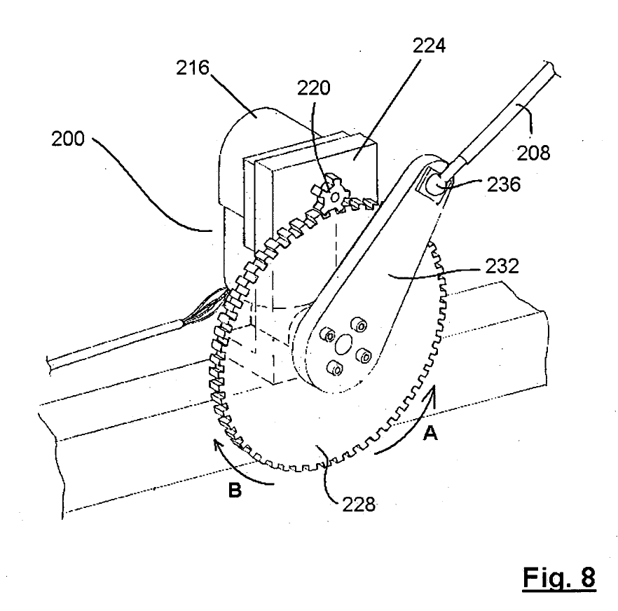

The operation of actuator 200 is best understood with reference to FIG. 8. As shown, actuator 200 includes a DC motor 216 to whose output shaft a pinion gear 220 is attached. DC motor 216 is mounted to an actuator mount 224, which is in turn mounted to the truck. A ring gear 228 is also mounted to actuator mount 224 via a suitable bearing mount (not shown) such that ring gear 228 is rotated about its center axis when pinion gear 220 is rotated by DC motor 216.

An actuator arm 232 is mounted to, and extends longitudinally from, the center of ring gear 228 ring and actuator arm 232 includes a mounting point 236 to which one end of lift rod 208 is pivotally attached.

As should now be apparent to those of skill in the art, as DC motor 216 is supplied with electrical current by an electronics controller (not shown), pinion 220 is rotated which, in turn rotates ring gear 228. When the current supplied to DC motor 216 is of a polarity which causes ring gear 228 to be rotated, by pinion 220, in the direction indicated by the arrow labeled A, actuator arm 232 moves lift rod 208 such that hood 28 is moved towards the closed position illustrated in FIG. 6.

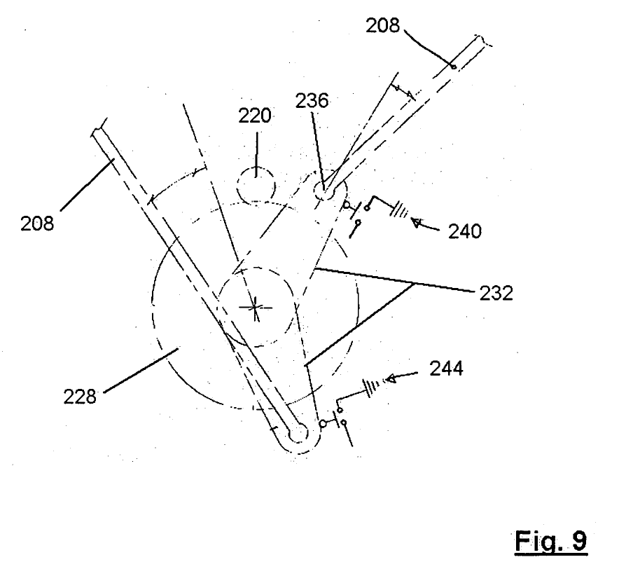

Conversely, when current is supplied to DC motor 216 with a polarity which causes ring gear 228 to be rotated, by pinion 220, in the direction indicated by the arrow labeled B, actuator arm 232 moves lift rod 208 such that hood 28 is moved towards the open position illustrated in FIG. 7. FIG. 9 shows the resulting geometry of actuator 200 and the range of movement of actuator arm 232 can be seen.

As with the embodiment of FIGS. 1 through 5, the supply and control of current to DC motor 216 to start, stop and control operation of actuator 200 can be accomplished in a wide variety of manners. For example, a manually actuated switch (not shown) similar to switch 100 can be used to manually control actuator 200. A remote control, such as an infrared or radio transmitter, can also be used. Further, as described before, electronics control circuitry including a stall sensor, current sensing circuitry (not shown), limit switches 240 and 244 (illustrated in FIG. 9) or other sensing devices can be employed to automatically stop supplying current to DC motor 216 when hood 28 reaches its fully closed or fully open positions and/or to prevent overdriving of motor 216.

Further, such control circuitry can be used, as described previously, for detecting unsafe conditions, such as hood 28 abutting an object and removing the supply of current to DC motor 216. As will be apparent to those of skill in the art, any other suitable means such as known ultrasonic and/or radar-like systems for detecting such unsafe conditions, as would occur to those of skill in the art, can also be employed with the control circuitry.

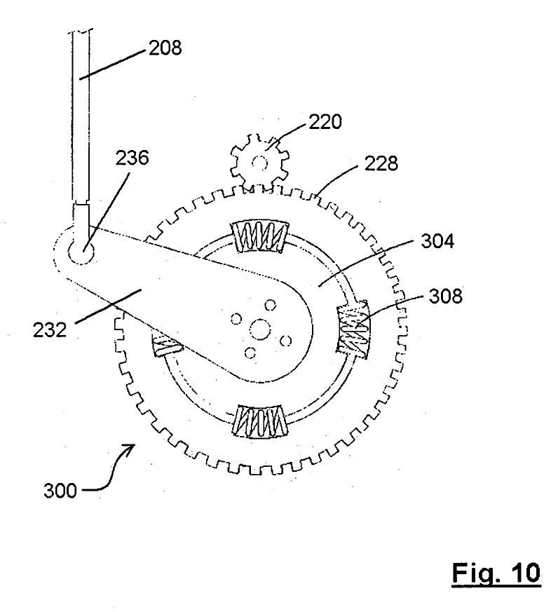

FIG. 10 shows another embodiment of the present invention wherein like components to those illustrated in FIGS. 6 through 9 are indicated with like reference numerals.

In the embodiment of FIG. 10, actuator 300 includes a pinion gear 220 driven by a DC motor (not shown in the Figure) as before. However, in this embodiment, a drive disc 304 is mounted co-axially with ring gear 228 and actuator arm 232 is mounted to drive disc 304. Both of drive disc 304 and ring gear 228 are mounted via bearings or other suitable means such that they can rotate independent of one another. A dampening member, in this example compression springs 308, are mounted to act between ring gear 228 and drive disk 304. As will now be apparent, when ring gear 228 is rotated by pinion gear 220, the resulting torque is transferred to drive disc 304, and thus to lift rod 208, via the springs 308. Springs 308 thus provide a dampening to actuator 300 to absorb shocks as the DC motor of actuator 300 starts and stops and as hood 28 moves to and from over-center positions, when opening and closing.

While the illustrated dampening member comprises springs 308, the present invention is not so limited and any suitable dampening member, such as one or more blocks of resilient material, can be employed as desired.

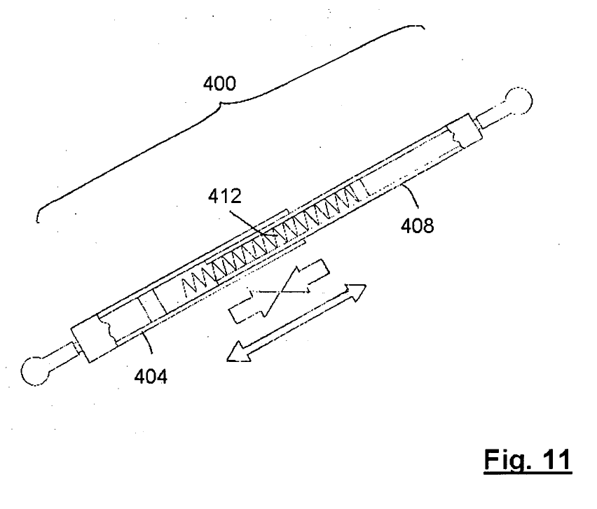

FIG. 11 shows an alternative construction for a lift rod assembly 400 to be used with the present invention to provide a dampening and/or mechanism if desired. Lift rod assembly 400 comprises a lower member 404 and an upper member 408 and a dampening member, in this example a coil spring 412, which interconnects members 404 and 408. The ends of coil spring 412 are captured by upper member 408 and lower member 404 such that, when lift rod assembly 400 is in compression, coil spring 412 is in compression, and when lift rod assembly 400 is in tension, coil spring 412 is in tension. Lift rod assembly 400 thus provides a dampening capability to absorb shocks as the DC motor of an actuator in accordance with the present invention starts and stops and as hood 28 moves to and from over-center positions, when opening and closing. The present invention is not limited to the use of coil springs for the dampening member in lift rod assembly 400 and other suitable dampening members, such as resilient or elastomeric members or hydraulic or gas springs are examples of other dampening members that can be employed. Lift rod assembly 400 can be employed with actuator 20, actuator 200 or actuator 300, as desired.

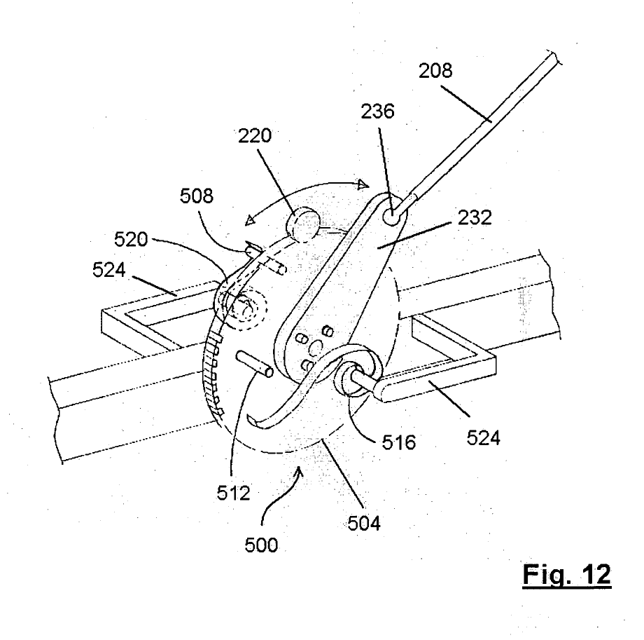

Another embodiment of the present invention is illustrated in FIG. 12 wherein like components to those described above are indicated with like reference numerals. In this embodiment, actuator 500 includes a ring gear 504 which includes a pair of longitudinally extending pins 508 and 512, one extending from each side of ring gear 504.

Ring gear 504 further includes a first torsion spring 516 and a second torsion spring 520 each of which has a respective one end affixed to a part 524 of the frame of the truck and a respective other end which extends towards the periphery of ring gear 504 as shown.

First spring 516 is arranged such that, when hood 28 passes the over-center point when moving from the open position toward the closed position, pin 512 abuts the free end of first spring 516 which biases pin 512, and ring gear 504, away from the closed position. Similarly, second spring 520 is arranged such that, when hood 28 approaches the open position from the closed position, pin 508 abuts the free end of second spring 520 which biases pin 508, and ring gear 504, away from the open position. By biasing ring gear 504 with a respective one of first torsional spring 516 and second torsional spring 520 during respective portions of the travel range of hood 28, first torsional spring 516 and second torsional spring 520 act as energy storage devices inhibiting the weight of hood 28 from overdriving the DC motor (not shown) and reducing the torque required to be delivered by the DC motor when starting to move hood 28 from either its fully open or fully closed positions as the DC motor is assisted by the biasing force which acts to counter the weight of hood 28. Thus, the size of the DC motor can be reduced, with a commensurate expected cost saving for actuator 500.

As will be understood by those of skill in the art, the present invention is not limited to the particular arrangement of torsional springs and pins, described above, to differentially bias ring gear 504 over its range of travel and it is contemplated that a wide range of alternative configurations and mechanisms will occur to those of skill in the art.

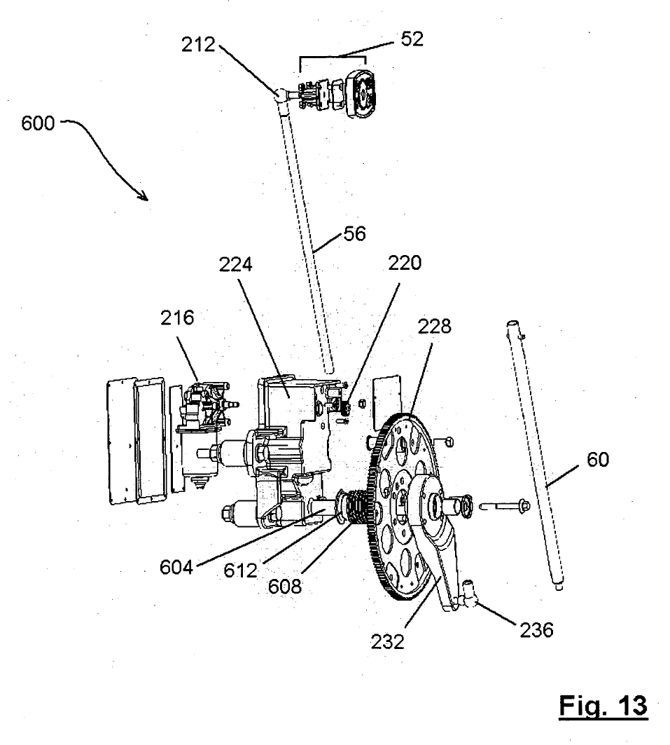

FIG. 13 shows another differentially biased embodiment of an actuator 600 in accordance with the present invention wherein like components to those described above are indicated with like reference numerals. In this embodiment, the shaft 604 on which ring gear 228 rotates is fixed with respect to housing 224 and arm 232 includes a hub with a bearing surface to allow arm 232, and ring gear 228 which is mounted to arm 232, to rotate on shaft 604.

Shaft 604 is surrounded by a coil spring 608 and one end of spring 608 is fixed to ring gear 288 and the other end of spring 608 is fixed to housing 224, or to a member (not shown) in the engine compartment of the vehicle. Preferably, coil spring 608 is fabricated and/or installed on actuator 600 such that its “at rest” position (wherein there are substantially no torsional forces on spring 608) corresponds to the position of ring gear 228 when the center of gravity of hood 28 is substantially over the mounting point 236, referred to herein as the centered position. Thus, spring 608 is tensioned in a first direction when hood 28 moves past the centered position towards the closed position of hood 28 and is tensioned in an opposite direction when hood 28 moves past the centered position towards the open position of hood 28.

By tensioning spring 608 in the corresponding direction as hood 28 is moved from the centered position, spring 608 serves as an energy storage device, preventing overdriving of DC motor 216 by the weight of hood 28. Further, the resulting biasing force exerted by spring 608 on ringer gear 228 assists DC motor 216 to move hood 28 from the open and closed positions towards the centered position.

If packaging constraints or other considerations prevent spring 608 from being arranged to act in both tension and compression, one end of spring 608, such as the end which was previously described as being fixed to ring gear 228, can instead be arranged to abut a feature (not shown, such as a boss or pin on ring gear 228 or on housing 224, etc.) such that spring 608 only biases ring gear 228 between the closed position and the centered position, after which point this end of spring 608 is disengaged and free to rotate about shaft 604. As will now be apparent to those of skill in the art, in this configuration spring 608 will only act as an energy storage and biasing device between the closed and centered positions.

However, if in this configuration it is desired to provide some energy storage mechanism during movement of hood 28 between the centered position and the open position, another mechanism, such as a second spring or the resilient lift rod (described below) can be employed.

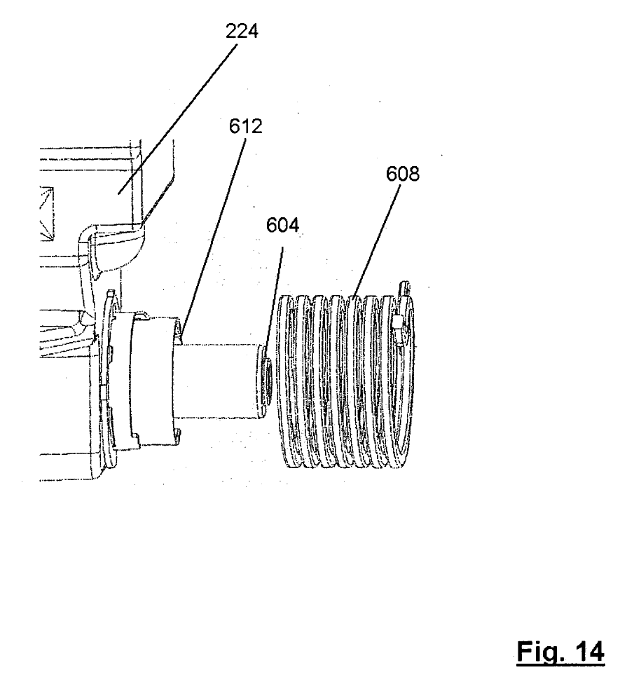

As another alternative, in the embodiment of FIG. 13 coil spring 608 can instead be configured with a noose ring 612, best seen in FIG. 14, to provide a dampening force on the hub of arm 232 as arm 232 rotates to close hood 28. Specifically, in this configuration, as spring 608 is tensioned when ring gear 228 rotates to close hood 28, the diameter of coil spring 608 about shaft 604 is reduced and this reduced diameter exerts a compressive force on noose ring 612 and, in turn, on the hub of arm 232. Noose ring 612 is fixed, by any appropriate means, with respect to housing 224 such that it cannot rotate and thus the compressive force on noose ring 612 results in a frictional dampening force being exerted on arm 232 as it rotates with ring gear 228 to close hood 28. This frictional dampening force assists in preventing overdriving of motor 216 by the weight of hood 28 as hood 28 is closed.

It is contemplated that the design of some engine compartments may limit the positions in which an actuator in accordance with the present invention can be installed and that the resulting installation may result in a less than optimal operating geometry for the actuator. In such cases, it is contemplated that it may be useful to employ a lift rod assembly whose length can vary, during opening and closing of the hood 28, between a first shorter length and a second longer length. Such a lift rod assembly can be constructed of two telescopically engaged members as before, except in this circumstance a pin, similar to pin 64 described above, would be inserted into a bore through one member and ride in a slot in the other member. As will be apparent, the first shorter length and second longer length are established as the pin abuts a respective end of the slot.

It is further contemplated a resilient member, for example a coil spring, can be arranged in the lift rod assembly to obtain a resilient lift rod assembly wherein the resilient member acts between the two telescopically engaged members such that energy is stored in the resilient member when the rod is compressed or tensioned. By compressing and/or tensioning the resilient lift rod assembly, both a dampening force and a motor assist force can be provided.

As mechanical movement of a moveable closure, such as a truck hood, can raise some safety concerns, the present invention preferably offers several safety features. As mentioned above, the control circuitry current to the DC motor of actuators in accordance with the present invention can include stall detector circuitry, such as current sensors or rotational movement detectors, to provide object collision avoidance capability, wherein current is removed from the DC motor if a collision between the truck hood and an object is detected.

Also, actuators in accordance with the present invention can include an piezeoelectric buzzer or other sound generating device which operates to provide an audible warning that the actuator is operating and the moveable closure is moving. Further, if the actuators in accordance with the present invention include a remote control, such as a radio or infrared remote, the remote control can be configured to operate in a failsafe mode wherein the button on the remote must be continually pressed to maintain operation of the actuator. For example, to open the truck hood, the user must press and hold the button on the remote corresponding to the open function until the hood is fully open. Releasing this button at any time during the opening operation causes the supply of current to the DC motor to be withdrawn, stopping operation of the actuator until the button is again pressed and held.

Alternatively, the remote can operate such that the user pressed a button corresponding to the desired operations (i.e.—open or close the hood) and the actuator will automatically perform the requested operation. If the user presses any button on the remote prior to completion of the requested operation, the control circuitry of the actuator interprets this signal as an emergency stop command and causes the supply of current to the DC motor to be withdrawn, stopping operation of the actuator.

In this latter case, wherein a second button press is interpreted as an emergency stop command, it is important to have a high level of confidence that the remote will continue to operate properly throughout the requested opening or closing operation. Accordingly, the remote preferably operates to determine the condition of its battery power supply and, when a button is pressed on the remote to signal the desired start of an opening or closing operation, the remote determines if its battery condition exceeds a predefined safe operating level.

If the predefined safe operating level is met, it is assumed that the battery power supply is in a sufficient condition to safely and reliably operate throughout the requested open or close operation and the remote transmits the appropriate command to the control circuitry on the truck to commence the requested operation.

If the predefined safe operating level is not met, the remote then compares the condition of its battery power supply to a predefined second level. If the determined battery condition is less than the predetermined safe operating level but greater than the second predetermined level, the remote can provide an indication of the determined state of its battery power supply to the operator, for example by flashing a warning LED on the remote and the remote transmits to the control circuitry both the appropriate command and a signal indicating the status of its battery power supply. In response to the receipt of the two signals from the remote, the actuator control circuitry commences the requested opening or closing operation and also provides another indication to the user that the state of the battery supply in the remote may be unsafe. This other indication can be any appropriate signal and, in a presently preferred embodiment, is provided by altering the sound from the above-mentioned piezeoelectric buzzer to provide an audible warning to the user that the battery of the remote should be replaced.

If the determined battery condition is less than the second predetermined level, the remote will send a signal to the control circuitry of the actuator indicating that condition and the actuator can then provide a fault code to the user, for example by beeping the piezeoelectric buzzer three times, to indicate that the power supply of the remote is not in a safe operating condition and must be replaced before the actuator will operate. At this point, the user can either replace the batteries in the remote or manually open or close the hood, as described above.

As another preferred safety feature, the control circuitry will operate the above-mentioned stall sensors such that the current levels which represent a detected stall condition are learned by the actuator for each installation. Specifically, as each installation of an actuator in accordance with the present invention will require the motor to produce a different peak torque over an opening and closing operation, due to a variety of truck-specific factors such as the weight of the hood, the installation geometry of the lift rod and hood pivot points etc., it is difficult to predefine appropriate maximum current levels at which the stall sensor should operate.

Accordingly, the actuator can be shipped with these maximum current levels set to a selected high level, for example at a point just below the current level at which damage will occur to DC motor. Once the actuator is installed on the vehicle, these pre-selected high levels will be used as the stall detection levels, but the control circuitry will monitor the actual measured maximum current levels experienced by the DC motor during a given number (e.g. twenty) of opening and closing operations. These measured maximum current levels, plus a small margin, are then used as the current levels which indicate a stall. Thus, an actuator in accordance with the present invention can learn appropriate stall level currents for its particular installation.

The present invention provides a truck hood actuator which, operating via a gear rack and DC motor-powered traveler or a pinion and ring gear mechanism, can operate more quickly than a hydraulic actuator, or a worm or screw gear actuator. Further, by employing the disclosed gear rack and traveler or pinion and ring gear, the actuator of the present invention can be readily employed and installed as an after market accessory or as OEM equipment at a lower cost than a hydraulic or other, more complex, actuators.

The above-described embodiments of the invention are intended to be examples of the present invention and alterations and modifications may be effected thereto, by those of skill in the art, without departing from the scope of the invention which is defined solely by the claims appended hereto.

We claim:

1. An actuator for opening and closing a moveable closure for the engine compartment of a truck or the like, comprising:
a gear rack for mounting to the truck;
a traveler including a motor and a pivot point, the motor operable to move the traveler along the gear rack; and
a lift rod extending between the pivot point on the traveler and a pivot point on the moveable closure, the lift rod moving the moveable closure to an open position when the traveler moves in a first direction along the gear rack and moving the moveable closure to a closed position when the traveler moves in a second direction along the gear rack.

2. The actuator of claim 1 wherein the traveler comprises a carriage to which the motor and pivot point are attached, the carriage being movable along the gear rack and the motor driving a pinion which engages the gear rack to move the traveler.

3. The actuator of claim 1 further comprising electronics controller connected to the motor, the electronics controller operable to deactivate the motor when the traveler reaches a defined first or second position on the gear rack.

4. The actuator of claim 3 wherein the defined first position corresponds to the moveable closure obtaining the open position the defined second position corresponds to the moveable closure obtaining the closed position.

5. The actuator of claim 4 wherein the electronics controller is further operable to deactivate the motor between the first and second positions as a safety stop if the moveable closure abuts another object.

6. The actuator of claim 3 wherein the electronics controller is responsive to a switch operable by a user.

7. The actuator of claim 6 wherein the switch is connected to the electronics controller by at least one wire.

8. The actuator of claim 6 wherein the switch is connected to the electronics controller via a radio link.

9. The actuator of claim 6 wherein the switch is connected to the electronics controller via an infrared link.

10. The actuator of claim 1 wherein the lift rod comprises an assembly of an upper rod and a lower rod, the upper and lower rods being kept in engagement by a removable member.

11. The actuator of claim 10 wherein the removable member can be removed to allow disengagement of the upper rod from the lower rod to allow manual opening of the closure member.

12. The actuator of claim 1 wherein the lift rod comprises an assembly of an upper rod and a lower rod, the upper and lower rods having a resilient member connecting them, the resilient member being compressed and/or tensioned to store and return energy from movement of the moveable closure.

13. An actuator for opening and closing a moveable closure for the engine compartment of a truck or the like, comprising:
a motor driven pinion gear;
a ring gear rotatably mounted to the truck and engaging the pinion gear, the ring gear further including an actuator arm extending radially from the ring gear; and
a lift rod extending between a pivot point on the actuator arm and a pivot point on the moveable closure, the lift rod moving the moveable closure to an open position when the pinion gear rotates in a first direction and moving the moveable closure to a closed position when the pinion gear rotates in a second direction.

14. The actuator of claim 13 further comprising a resilient member acting between the ring gear and a stationary member to store energy from the pinion when the pinion rotates in one direction and to return energy to the pinion when the pinion rotates in an opposite direction.

15. The actuator of claim 13 further comprising a noose ring and a torsion spring, the torsion spring acting between the ring gear and the truck such that the diameter of the torsion spring is reduced, compressing the noose ring, as the ring gear is rotated to close the moveable closure and wherein the compressed noose ring exerts a frictional dampening force on the ring gear.
